(19) United States
(12) Patent Application Publication
(10) Pub. No.: US 2006/0082595 A1
(43) Pub. Date: Apr. 20, 2006

(54) Device part assembly drawing image search apparatus

(75) Inventors: Rujie Liu, Beijing (CN); Takayuki Baba, Kawasaki (JP); Susumu Endo, Kawasaki (JP); Shuichi Shiitani, Kawasaki (JP); Yusuke Uehara, Kawasaki (JP); Daiki Masumoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/169,805

(22) Filed: Jun. 30, 2005

(30) Foreign Application Priority Data
Oct. 15, 2004 (JP) 2004-302328

(51) Int. Cl. G09G 5/00

(52) U.S. Cl. 345/629

(57) ABSTRACT

A query device part image and an assembly drawing image from a drawing database which is a search target are input. The assembly drawing image is classified into text and non-text areas in the layout analysis unit 10. In the device part extraction unit 11, part images are extracted from non-text areas. The device part comparison unit 12 collates the extracted part image and the query device part image.

### BACKGROUND OF THE INVENTION

1. Field of the Invention

The present invention relates to a means for extracting and collating device part assembly drawing images.

2. Description of the Related Art

The effective management and search of technical drawings which already exist in paper form is an issue which needs immediate resolution. According to statistical data, the number of technical drawings reached 3.5 billion pages in the 1990's in the United States and Canada alone and increases by an estimated 26 million pages per year. The annual cost for filing, referencing, and managing these drawings exceeds 1 billion dollars. Researchers who have begun studying means for electronically managing technical drawings, to cut maintenance costs, improve the understanding of technical drawings and efficiency in regards to content collation, search, and the like, are emerging.

Collation and search of technical drawings based on content are extremely important in application. For example, preexisting technical drawings are referenced when an engineer plans the design of or modifications to a certain product. In this case, conventionally, the engineer must view drawings one by one to find the necessary drawing, and large amounts of time and effort are consumed. A search based on textual content has been proposed as a solution to this problem. This is a method which, for example, attaches text tags to each drawing as keyword indexes. Although this information is convenient when searching a graphical document in its entirety, millions of drawings must be labeled, and a great effort is required. Furthermore, explanations of drawing contents through text labels such as these cannot completely and exhaustively accommodate all of the images used for collation, and normally cannot indicate the position, within the technical drawing, of the area corresponding to a query image. If an automatic search and collation technology based on the drawing content can be achieved, the efficiency of searching drawings such as these will be improved dramatically, and the management cost of technical drawings will be cut significantly.

A publicly-known technology is one wherein technical drawing primitives are collated by implementing an F-signature. Refer to Non-Patent Reference 1. However, this method only enables collation and search of segregated primitives within the technical drawing, and does not realize segment detection and segment comparison. Therefore, its application range is limited.

Pasi Franti proposed a method for searching for technical drawings based on content by specifying the global characteristics of lines using Hough conversions. Refer to Non-Patent Reference 2. This method handles each technical drawing in its entirety and does not accommodate segment comparisons. Furthermore, the line characteristics are only effective in comparisons of drawings consisting of lines, curved lines and the like, and limit application range.

Another publicly-known method is one wherein technical drawings which comprise a device part similar to the query image from a database utilizing text and graphical configuration information are searched. Refer to Patent Reference 1. In this method, text is input as input data, an index is referenced by textual geometric descriptions, and finally, the existence of the part which corresponds to the query image within the technical drawing is acknowledged. This method is essentially dependent on the text search mode.

Non-Patent Reference 1

S. Tabbone, L. Wendling, K. Tombre, Matching of graphical symbols in line-drawing images using angular signature information, International Journal Document Analysis and Recognition, Volume 6, Issue 1, June 2003

Non-Patent Reference 2

Pasi Franti, Alexey Mednonogov, Ville Kyrki, Heikki Kalviainen, Content-based matching of line-drawings using the Hough transform, International Journal of Document Analysis and Recognition, Volume 3, Issue 2, December 2000

Patent Reference 1

U.S. Pat. No. 5,845,288 Specifications

As is stated above, research and development of search and collation technology based on drawing content has just started, and sufficient technology has not been developed.

### SUMMARY OF THE INVENTION

The objective of the present invention is to provide an image search for device parts within assembly drawings which can match device part images corresponding to a query device part image from within an assembly drawing by comparing the device parts comprised in the drawing and the query image.

The device part image search device according to the present invention is a device part image search device for collating an image of a device part in a technical drawing with a query image, which detects lines drawn in a technical drawing, and comprises: a segmentation means for dividing a technical drawing into one or more sub-areas, a non-text area determination means for determining whether the sub-area is a text area which is comprised mainly of text or a non-text area which is comprised mainly of contents other than text, an extraction means for extracting device part images corresponding to non-text data, and a collation means for collating the query image and the extracted device part images.

According to the present invention, an effective assembly drawing device part extraction collator based on the drawing content can be provided.

### BRIEF DESCRIPTION OF THE DRAWINGS

FIG. 1 is a block diagram showing the configuration of a device part extraction collator for assembly drawings according to the present invention;

FIG. 2(a) is a diagram showing horizontal and vertical projection histogram tables and a diagram document table from which the histogram tables were created; (b) is a diagram indicating the relation between an actual table and a table obtained from the first table line detection;

FIG. 3 shows pseudo-code for executing the table connection process in a grid;

FIG. 4(a) is a diagram showing the set area and its original profile and smoothed profile; (b) is a diagram showing the first derivative of the smoothed profile in FIG. 4(a); (c) is a diagram showing border lines of each text line in the area in FIG. 4(a);

FIG. 5 is a diagram showing the segmentation of a text row into envelope rectangles regulated by each connected component;

FIG. 6 is a flowchart showing the flow of processing from input to separation process;

FIG. 7 is a diagram showing a flowchart of the device part extraction process;

FIG. 8 is a diagram showing an example of a contour operation process;

FIG. 9 is a diagram showing the scanning order of a device part image grid;

FIG. 10 is a diagram (1) showing the results of processing according to an embodiment of the present invention in sequentially typified form;

FIG. 11 is a diagram (2) showing the results of processing according to an embodiment of the present invention in sequentially typified form; and

FIG. 12 is a diagram (3) showing the results of processing according to an embodiment of the present invention in sequentially typified form.

### DESCRIPTION OF THE PREFERRED EMBODIMENTS

Assembly drawings are of a more specialized and important type of technical drawings and are normally used to show the parts comprising a device and how these parts are assembled. In actual application, all drawings are searched from data comprising specific device parts. Therefore, the assembly drawing device part extraction collator extracts device part images from the assembly drawing and compares them with the query device part image. The assembly drawing device part extraction collator comprises a layout analysis unit for eliminating text areas from the assembly drawing, a device part extraction unit for grouping each device part by a merge and separation process, and a device part comparison unit for comparing the extracted device part images and the query part image to select a feature for detecting images of the part corresponding to the query image from the assembly drawings.

The objective of layout analysis is to separate graphic areas from text areas within a drawing. This begins with processing an area which is in table form, formed by lines detected within the assembly drawing. Based on the blank areas surrounding the entire drawing, the orientation of the document page is evaluated and the angle of the drawing is corrected. Then, according to the configuration of the blank area, the drawing is divided into rough areas and, at the same time, these areas are labeled as either text areas or non-text areas, based on the projection histogram characteristics. Next, the non-text areas are recursively divided at blank regions into smaller areas, and this process is continued until further subdivision is not possible.

Device part extraction is performed only on the non-text areas obtained above as text areas have no graphic components and thus device part collation search is not required. Device part extraction is performed by connected component analysis. First, all connected components within the contour of another component are merged to prevent device parts from becoming separated from each other. Then, device components connected by interpretation lines are separated through the separation process. Separated areas are processed, through this process, to comprise only one device part.

As a result of layout analysis and device part extraction, the device parts comprised within an assembly drawing are separated into individual images. Therefore, collation of the query device part image and the assembly drawing is a collation of the query device part image and these divided device part images. Thus, images are divided into a grid and a process for determining feature quantity through Fourier transformation is performed.

The collation of the query device part image and the assembly drawing, can be considered, an issue of searching objects, and the location of the target area, the size, and the direction must be taken into consideration simultaneously. In the present invention, device part images within the assembly drawing are extracted first, as the issue of determining the location of the target area can be solved easily. Therefore, the collation process can be realized simply and effectively.

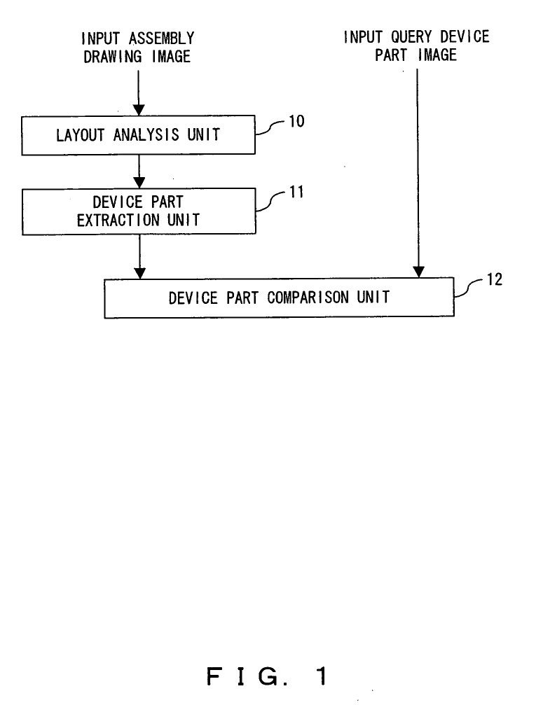

FIG. 1 is a block diagram showing the configuration of a device part extraction collator for assembly drawings according to the present invention. The configuration of a device part extraction collator for assembly drawings comprises three units: a layout analysis unit 10; a device part extraction unit 11; and a device part comparison unit 12.

Input assembly drawing images are preferably binary format images, but if non-binary format images are input, binarization pre-processing is performed.

1. Layout Analysis Unit 10

The images in an assembly drawing are generally a combination of text and graphic areas. Text areas normally describe the device parts, and include names of and the type of the assembly. However, these text areas are not effective in device part collation searches based on a query image. The objective of layout analysis is to separate and eliminate text areas from graphic areas within the drawing.

1.1 Blank Area Detection and Orientation Correction

One of the prominent characteristics of an assembly drawing is the blank area surrounding the entire drawing. This blank area generally covers the entire page of the assembly drawing and indicates the valid areas of the drawing. Aside from this, a blank area is normally implemented to divide a diagram document into various functional areas such as graphical, textual, and a title area.

The connected component of a drawing image is determined to be blank if the following conditions are met:

(1) The ratio of the size of the connected component comprising adjoining pixels and the drawing image is greater than the predetermined threshold (this threshold should be set accordingly by a person skilled in the art);

(2) The number of pixel comprising the image is significantly smaller than that of the background;

(3) The connected components are not comprised within other connected components;

(4) The connected components are configured only by straight lines.

The algorithms for finding areas which meet these conditions are considered well-known in the technical field of the present invention, and therefore, detailed explanations are omitted.

Furthermore, by analyzing the direction of the straight lines comprising the blank area, the orientation of the diagram document is ascertained and direction correction of the diagram document is performed.

1.2 Table Detection and Separation Based on Said Table

Here, a configuration comprising a rectangular segment formed by lines drawn in a diagram document is called a table. Table detection is performed based on projection histogram characteristics. A projection histogram is a histogram of each row or column of pixels wherein the pixel value is added either horizontally or vertically. Hereinafter, a “row or column” is referred to simply as a “row”. The criteria used in determining tables are as follows:

(1) The added pixel value of each row in a horizontal or vertical projection histogram corresponding to a table line is generally a large figure. Line widths generally have similar values.

(2) The distribution of the added pixel value of rows other than the table line in a horizontal or vertical histogram has a small variance and an extremely small peak value.

Through this process, the connected components of the pixels are classified by whether or not they are table lines. Simultaneously, the location of the table line can be determined, from the histogram, to be a row which has a very large pixel value.

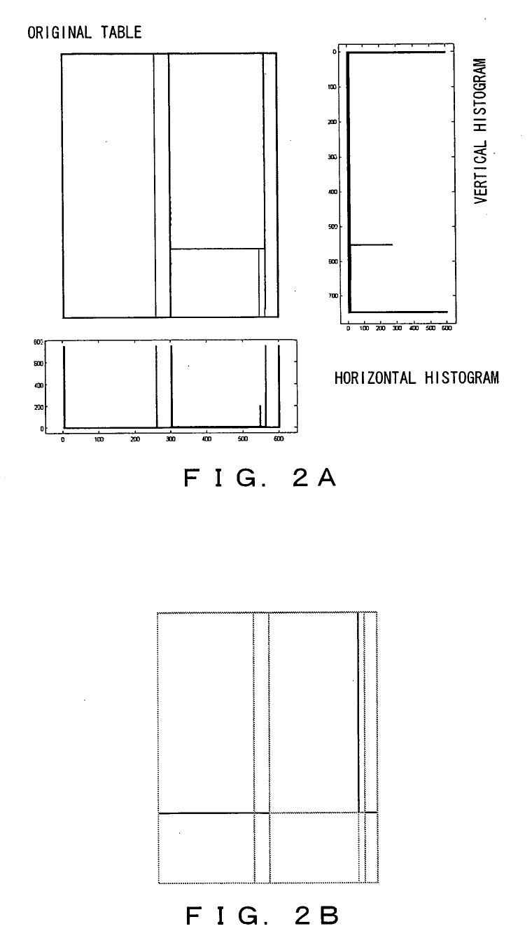

FIG. 2(a) are diagrams showing horizontal and vertical projection histogram tables and a diagram document table from which the histogram tables were created.

After table detection and table line determination, grids for each table are obtained. Here, a grid is a rectangular area separated by lines. First, a drawing is broken up horizontally into a plurality of rectangular grids at the location of the table line where the table area was detected. This first grid is not divided by lines (table lines), and a combination of these grids cover the entire area.

FIG. 2(b) is a diagram indicating the relation between an actual table and a table obtained from the first table line detection.

The separation result of the first table in FIG. 2(a) is shown in FIG. 2(b). Here, the light lines show the actual table lines. Next, this first separated grid is merged into a natural table as below by the area growth method.

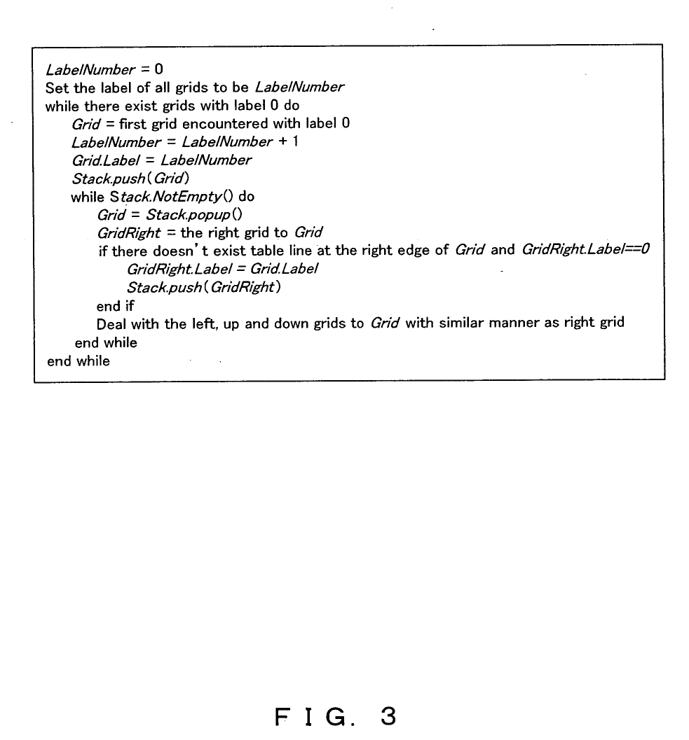

FIG. 3 shows pseudo-code for executing the table connection process in a grid.

First, the Label Number is set to 0. Next, the Label Number of all of the grids is set to 0. Then, a grid whose Label Number is 0 is found and Grid is set to the grid number where the Label Number is 0. Here, a grid number is a number given to each grid at the time of table extraction. Next, the Label Number of the grid to be processed is incremented by one, and the Label Number is set to the label data of the data stack of the grid. Data is written to the data stack indicated by the Grid number returned by a Stack.push operation. Next, stacks which are not empty are found, and data is read into Grid by a Stack.pop operation. Then, the data in the grid on the right-hand side of the grid is read into GridRight. It is assumed that the grid numbers and their position relations are obtained beforehand, at the time of table extraction.

Next, whether or not lines exist between the grid indicated by Grid and GridRight is detected. Although various methods are known, one example is a method wherein the corresponding segments of the original drawing data are scanned to determine whether or not lines exist.

If it is determined that there are no lines, data is written to the GridRight grid so that the label number of GridRight is the same as the label number of Grid.

This process is performed on the left, right, top and bottom boundaries of this grid, and furthermore, on all of the grids, and a merging process of the grids is completed.

Through the process above, labels are given to all of the first grids, and grids with the same label are merged into the original table grid.

According to these original table grids, the diagram document is broken up into a plurality of large areas. If these grids are obtained through blank areas, the entire document is covered, or additional areas must be added to complete the merging of these areas, depending on the combinations of these grids. If there are no blanks or other tables, further separation processing based on tables is not necessary.

1.3 Identification of Text Areas

The text lines of a paragraph are aligned either vertically or horizontally, have about the same width, and furthermore, are distributed so as to be segmented by white stripes (white background, blank areas). The distributed characters in a text line are aligned vertically or horizontally, have about the same width, and are separated by white stripes, as are the text lines of a paragraph. Text areas can be differentiated from other areas by projection profile through these characteristics.

First, the projection profile of a set area within each grid is calculated. This area is one which comprises each connected component, and a histogram of this small area is created. The set area is based on each grid, and from this, if the grid is divided by a white stripe, the set area is an area divided by this white stripe. In other words, the pixels comprised in the enclosing rectangle of each connected component is set to 1, and the other pixels in the set area are set to 0. A smoothing process is implemented to control the amount of detail in the projection profile. The projection profiles obtained before and after smoothing are called the original profile and the smoothed profile, respectively, and are indicated by P^{c} and P^{s}. P^{s}=P^{o}×f (Here, f is a filter of some type)

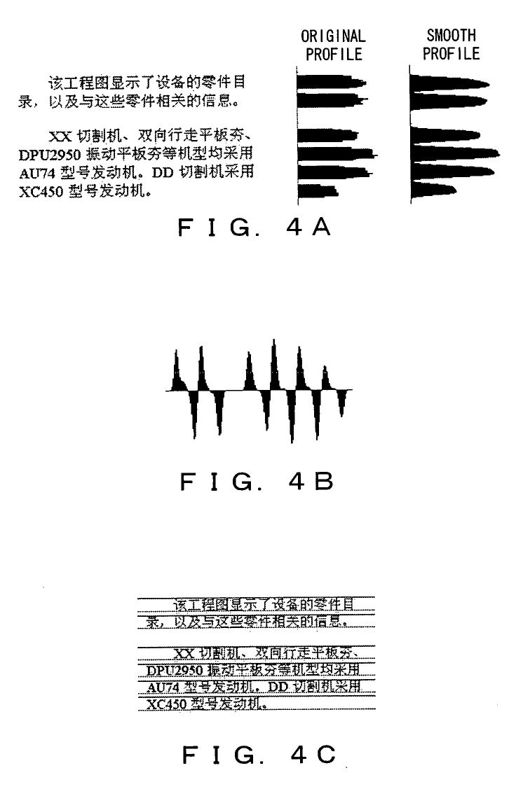

FIG. 4(a) is a diagram showing the set area and its original profile and smoothed profile. Next, the first derivative, which is the angle of the tangent line to the smoothed profile, is defined and calculated as below to determine the maxima and minima of the smoothed profile.

$$D = \{ {d}_{n} \vert {d}_{n} = \frac{{\sum }_{m = 1}^{w} {p}_{n + m}^{S} - {\sum }_{m = 1}^{w} {p}_{n - m}^{S}}{2 * {\sum }_{m = 1}^{w} m} \}$$

Here, P^{s}ₙ and dₙ are the pixel values of a row in the smoothed profile and the first derivative of this profile, respectively. n is the sequence number of the row, and w should be set accordingly by persons skilled in the art.

FIG. 4(b) is a diagram showing the first derivative of the smoothed profile in FIG. 4(a).

Subsequently, the point at which the first derivative of the smoothed profile becomes 0 (zero point) is used to obtain the borderlines of each text line.

(1) The maxima and minima of the smoothed profile are determined. The zero points which meet the conditions below correspond to the maxima and minima of the smoothed profile, respectively.
MAXₙ={n|dₙ>0, and dₙ₊₁≦0}
MINₙ={n|dₙ<0, and dₙ₊₁>0}

Alternatively, maxima and minima may correspond to line segments as opposed to a point. In this case, the equation above becomes that below:
MAXₙ={n|n=(i+j)/2, dⱼ₋₁>0, dⱼ₊₁<0, dₘ=0, i≦m≦j}
MINₙ={n|n=i . . . j, dⱼ₋₁<0, dⱼ₊₁>0, dₘ=0, i≦m≦j}

(2) Borderline detection. The maximum obtained above can be assumed to correspond with one text line. The borderline of each text line can be determined as follows, using the minimum and the original profile.

The minimum point in both directions from each maximum point or the zero point of the original profile is determined. The first minimum point encountered or the zero point of the original profile becomes the border line of this direction. If points such as these are not found before encountering another maximum point, the present maximum point is discarded. FIG. 4(c) is a diagram showing borderlines of each text line in the area in FIG. 4(a)

(3) Characteristics extraction. Up to this point, a pair of borderlines and the corresponding maximum have been obtained and are expressed by {(1¹ₙ, mₙ, 1²ₙ)|1¹ₙ<mₙ<1²ₙ, n=1 . . . N}. Here, n is the index numbering the text lines comprised in the set area. This index is assigned respectively to the set areas presently being processed, and if addition is performed on n, for example, addition is performed on the set area within the set grid obtained by table extraction.

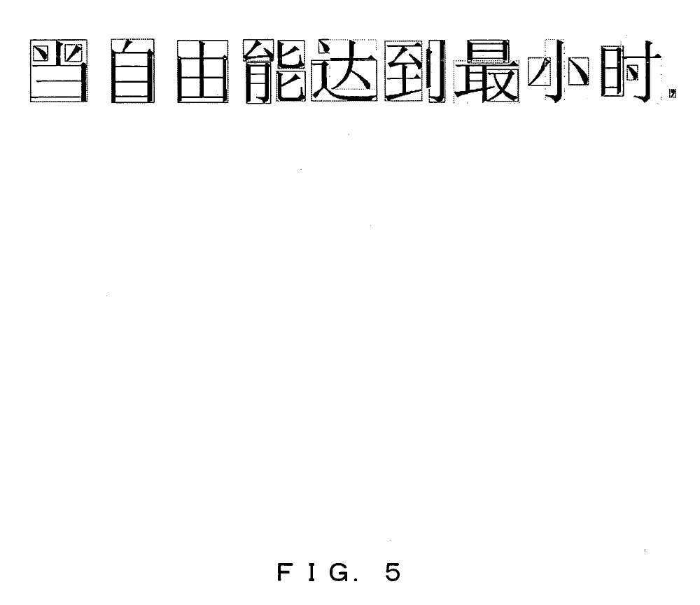

FIG. 5 is a diagram showing the division of a text line into enclosing rectangles regulated by each connected component.

Three feature quantities are calculated to identify text areas based on these rectangles.

Dimensional uniformity, DU, measures uniformity of the width of the text lines.

$$DU = \frac{var}{M} , var = \frac{{\sum }_{n = 1}^{N} {( {l}_{n} - M )}^{2}}{N} , {l}_{n} = {l}_{n}^{2} - {l}_{n}^{l} , M = \frac{{\sum }_{n = 1}^{N} {l}_{n}}{N}$$

Here, 1ₙ is the width of the text line, M is the average width of the text lines, and “var” is the variance of the width of the text line.

Covering uniformity, CU, measures distribution of the characters in the text line. If the connected component of pixels comprising characters divided by a region formed by border lines [1¹ₙ and 1²ₙ] and comprised in this region is expressed as cᵢ, i=1 . . . I, and the height and central position of the enclosing rectangle surrounding these connected components are expressed as hᵢ, tᵢ, i=1 . . . I, the covering uniformity of this region is:

$${CU}_{n} = {\sum }_{i = 1}^{l} ( {H}_{i} * {T}_{i} ) / I$$

$${H}_{i} = \{ \begin{matrix}1 , & if & {h}_{i} < {l}_{n}^{2} - {l}_{n}^{1} \\ exp ( - \frac{{( {h}_{i} - ( {l}_{n}^{2} - {l}_{n}^{1} ) )}^{2}}{2 * {σ}^{2}} ) , & if & {h}_{i} > {l}_{n}^{2} - {l}_{n}^{1}\end{matrix} \\ {T}_{i} = \{ \begin{matrix}1 , & if & {l}_{n}^{1} \leq {t}_{i} \leq {l}_{n}^{2} \\ 0 , & & otherwise\end{matrix}$$

Here, σ is set accordingly by persons skilled in the art. Also, CU is defined as the covering uniformity of the average of all of the regions comprised in the set area. Here, Hᵢ is a function which is 1 when the width of the connected component comprised in the text line is comprised in the width of the text line, and a small value if the width of the connected component is not comprised therein. Tᵢ is a function which is 1 when the central position of the connected component is comprised in the width of the text line, and 0 if it is outside of the width. By using these functions, a function of which the value is large if the width of a connected component is comprised in a text line and the position of the connected component is comprised in the width of the text line, and the value is small if not, is created.

$$CU = \frac{{\sum }_{n = 1}^{N} {CU}_{n}}{N}$$

Here, CU is the average within the set area. The Maximum to minimum ratio is abbreviated as MMR. The maximum determined above generally corresponds to the space between two text lines, and therefore, takes an extremely small value in the smoothed profile. The MMR is thus defined to characteristically-condition these features.

$$MMR = \frac{1}{N} {\sum }_{n = 1}^{N} \frac{( {p}_{{l}_{n}^{1}}^{S} + {p}_{{l}_{n}^{2}}^{S} )}{{p}_{{m}_{n}}^{S}}$$

Here, the definition of MMR is the sum of the pixel values of the borderlines of the text line divided by the maximum value, averaged out within the set area.

From these three feature quantities, text areas can easily be differentiated from the other areas by setting thresholds.

For example, if the dimensional uniformity has a value close to 0, the covering uniformity a value close to 1, and the maximum to minimum ratio a value close to 0, the area is determined to be a text area.

1.4 Separation

Non-text areas must be divided further. The 0-valued sections within the original horizontal vertical projection profile are checked, and the largest section within the profile where the 0-value continues is determined to be the position and direction of the separation of non-text areas. Therefore, non-text areas are separated into two sections by the largest white areas.

The separation process is repeated in all of the non-text areas until further separation is not possible, or in other words, until there are no more white areas.

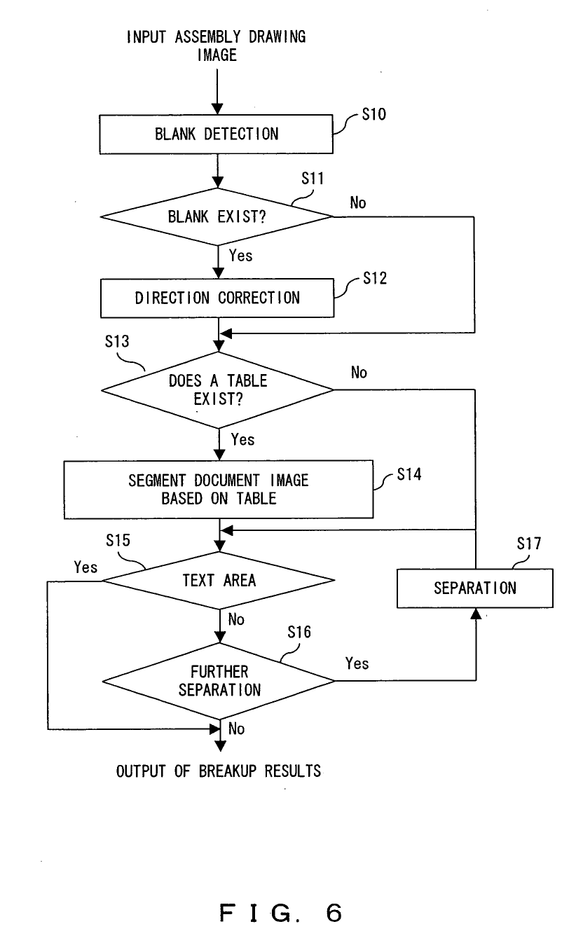

FIG. 6 is a flowchart showing the flow of processing from input to separation process. In the flowchart in FIG. 6, first, an assembly drawing image is input. Blank detection is performed in step S10. Whether or not a blank area exists is determined in step S11. If the determination of step S11 is “No”, the process moves on to step S13. If the determination of step S11 is “Yes”, the orientation of the diagram document is corrected in step S12. Whether or not a table exists is determined in step S13.

If the determination of step S13 is “No”, the process moves on to step S15. If the determination of step S13 is “Yes”, step S14 divides the document based on the table. Step S15 determines whether or not the area to be processed within the divided areas is a text area. If the determination of step S15 is “Yes”, the segmentation results are output. If the determination of step S15 is “No”, step S16 determines whether or not further divisions will be made. If the determination of step S16 is “No”, the segmentation results are output. If the determination of step S16 is “Yes”, division is performed in step S17, and the process returns to step S15.

2. Device Part Extraction Unit

After layout analysis, the document is divided into small areas and classified into text areas and non-text areas. The device part images effective in collation and search are extracted from non-text areas only. Therefore, only the non-text areas obtained above are processed by the device part extraction unit.

Device part extraction comprises (1) contour operation, (2) merging, (3) separation, and (4) a label text elimination step, based on connected component analysis and morphological operation.

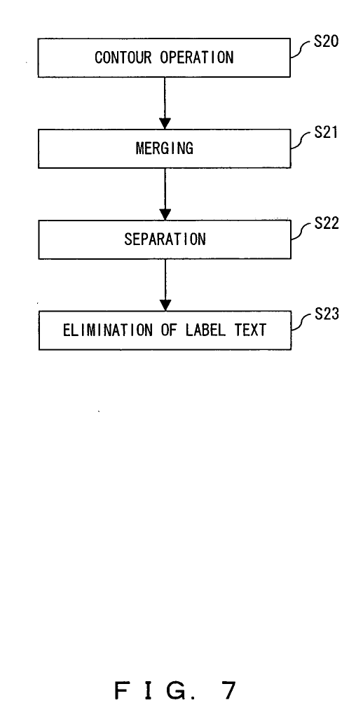

FIG. 7 is a diagram showing a flowchart of the device part extraction process.

First, contour operation is performed to extract the contour in step S20. In step S21, device part images are merged. In step S22, device part images which have been unnecessarily connected are separated. In step S23, label text which is connected to the part image by interpretation lines is deleted.

Each step is described in detail below:

(1) Contour Operation

The contour is first extracted in regards to each connected component in the relevant non-text areas. A known method can be applied to this process. Refer to Luciano da Fontoura Costa and Roberto Marcondes Cesar Jr., Shape Analysis and Classification: Theory and Practice, CRC Press LLC, pages 341-347.

The contour may suffer deterioration and may be cut into a plurality of parts when a paper diagram document is scanned into an image or due to noise caused by the binarization process. Therefore, a dilation operation is implemented to correct the openings in the contour. Refer to I. Pitas, Digital image Processing Algorithms and Applications, A Wiley-Interscience Publication, Pages 361-369.

The contour obtained through these methods is a closed curve. The inside of this curve indicates the area occupied by the connected component. Furthermore, in order to obtain an area corresponding to the actual connected component, an erosion process is performed to remove artifacts of the dilation process.

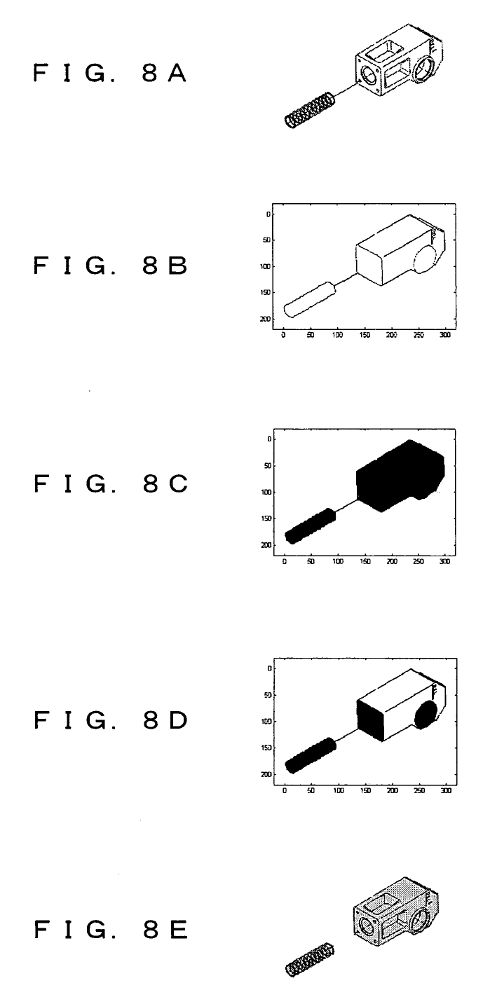

FIG. 8 is a diagram showing an example of a contour operation process. FIG. 8(a) shows the first connected component, FIG. 8(b) shows the contour obtained from the image in FIG. 8(a), FIG. 8(c) shows the area occupied by this connected component, and FIG. 8(d) shows the areas occupied by the connected component which is obtained when the contour correction process is not performed.

(2) Merging

The separation of the device parts image into a plurality of connected components occurs often. Therefore, each area held by connected components is checked. If a connected component which is completely covered by an area held by a certain connected component is found, the area of the connected component which is covered is merged with the area of the connected component which is covering. Therefore, the device parts image is not unnecessarily divided.

(3) Separation

The lines of the assembly drawing are formed mainly by two types; lines which form the device part object and lines (called interpretation lines) which label and connect objects, indicate internal/external relations, and explain the object. The objective of the separation process is to separate device parts which are connected by interpretation lines, and to delete interpretation lines. This operation is performed using the characteristic wherein the interpretation line is generally significantly thinner in comparison to the size of the device parts object.

First, a morphological erosion process is applied to the area surrounding the connected component. Through this process, the thin interpretation lines which are associated with the device object are removed. As a result the number of pixels decreases dramatically due to the erosion process, and if this area is determined to be a thin line-like shape, the corresponding connected component is determined to be an interpretation line and deleted.

FIG. 8(e) is a diagram showing the separation results of the image in FIG. 8(a).

(4) Label Text Removal

Text, which denote size information and the like, and index numbers of device parts exist even in non-text areas. To reduce the burden on the latter collation process, this text should be eliminated. This can be realized easily by analyzing the histogram of the relative occurrence frequency of the part as a function of the area. Refer to Lloyd Alan Eletcher and Rangachar Kasturi, A Robust Algorithm for Text String Separation from Mixed Text/Graphics Images, IEEE Transactions on Pattern Analysis and Machine Intelligence, Volume 10, No.6, page 910-918, 1988.

3. Device Parts Comparison Unit

After the layout analysis unit and device part extraction unit processing, all of the device part images comprised in the assembly drawing are extracted. If a comparison is made, these extracted device part images are collated with the input query image. The extracted device part images are used as separate and independent images.

Several known methods can be used to make comparisons. For example, the Grid Pixel Distribution method, explained below.

The device parts comparison unit creates a vector by inputting a binarization device part image, dividing this image into grids in a polar coordinate space, and calculating the pixel of each grid by a prescribed method, and determines the feature quantity for comparison by Fourier transformation. This feature quantity is an Affine invariant and does not change even under translation, rotation, or scale conversion.

(1) Coordinate space conversion which converts the pixel coordinates of the image from orthogonal coordinates to polar coordinates. In order to reduce the influence of pixel coordinate transformation by translation transformation, the center of the device parts image is defined as the origin of the polar coordinate system.

(2) Grid generation. The area between the pixel farthest from the origin of the device parts image and the origin of the polar coordinate system is divided into m areas in the radial direction of the image (m is an arbitrary natural number), divided into n areas in the angular direction (n is an arbitrary natural number), and all device image images are divided into an “m×n grid”.

(3) Grid pixel distribution feature quantity extraction.

First, the number of device part pixels within each grid is counted.

Next, the grid is scanned in the radial direction, and a vector is generated as is shown below. The number of pixels in the grid is in accordance to each pixel of this vector.

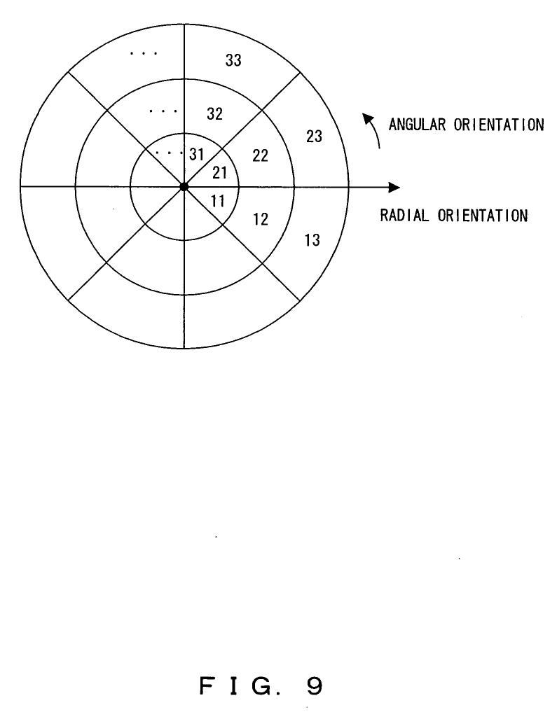

FIG. 9 shows the scanning order of the grids. The number of pixels in grids with the label mn is expressed as Cₘₙ and vectors generated in FIG. 9 are expressed as {c₁₁, c₁₂, c₁₃, c₂₁, c₂₂, c₂₃, c₃₁, c₃₂, c₃₃ . . . }.

Finally, Fourier transformation is performed on the vectors generated above which indicates the grid pixel distribution, and finally, the magnitude of the Fourier coefficient is used as the feature quantity (vector) for comparison.

(4) Comparison. The feature quantity for the two input binary images corresponding to the query image and the device part image extracted from the assembly drawing are obtained by steps (1) to (3), and the Euclidean distance of the two feature quantity vectors is calculated as the degree of similarity between the two images.

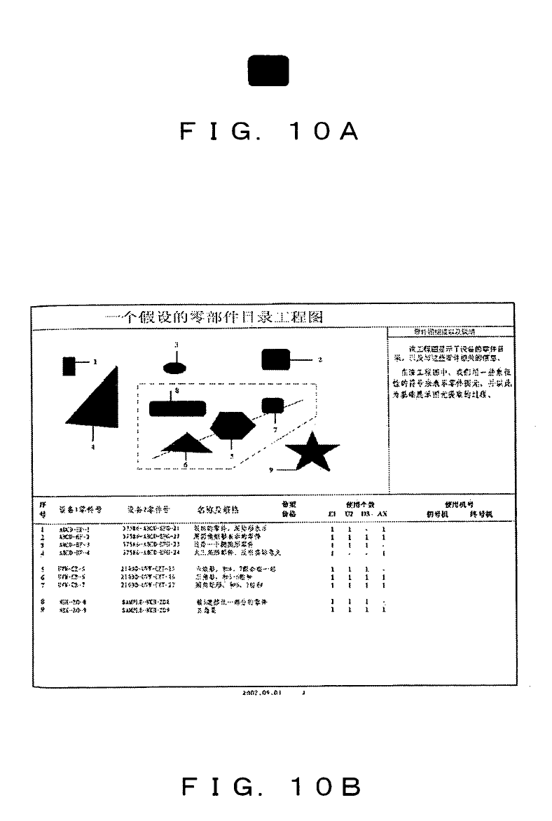

FIG. 10 to FIG. 12 are diagrams showing the results of processing according to the embodiment of the present invention in sequentially typified form.

FIG. 10(a) and FIG. 10(b) show the query device parts image and the assembly technical drawing image, respectively.

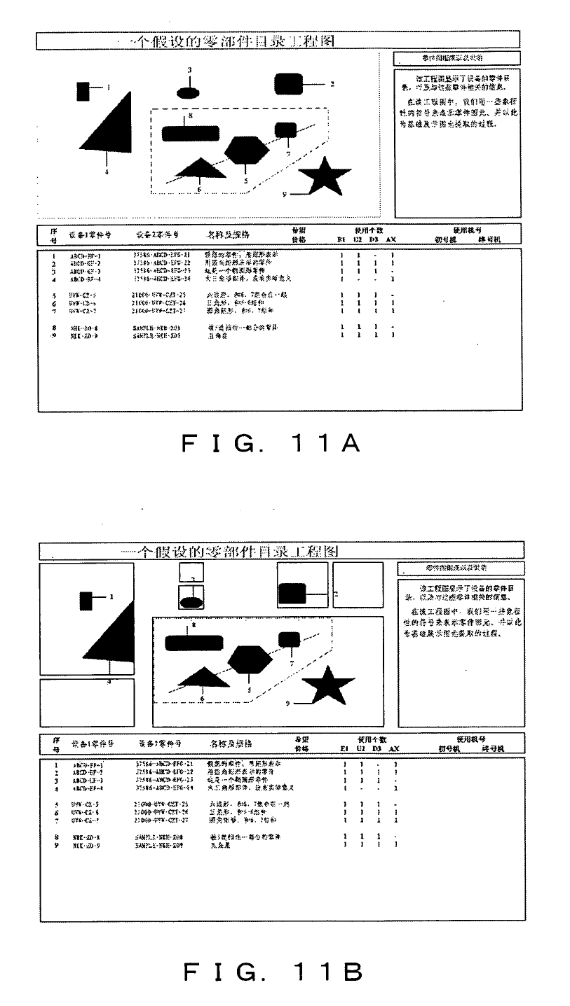

FIG. 11(a) shows the segmentation results by blank area, the classification into text and non-text areas, and the specification results of the text area. In FIG. 11(a), the rectangle with thick lines and that with thin lines express text and non-text areas, respectively.

Next, the division process is performed on the obtained non-text area recursively, until further division is not possible. FIG. 11(b) shows the final layout results. As above, in this diagram, text and non-text are expressed by rectangles with thick lines and thin lines, respectively.

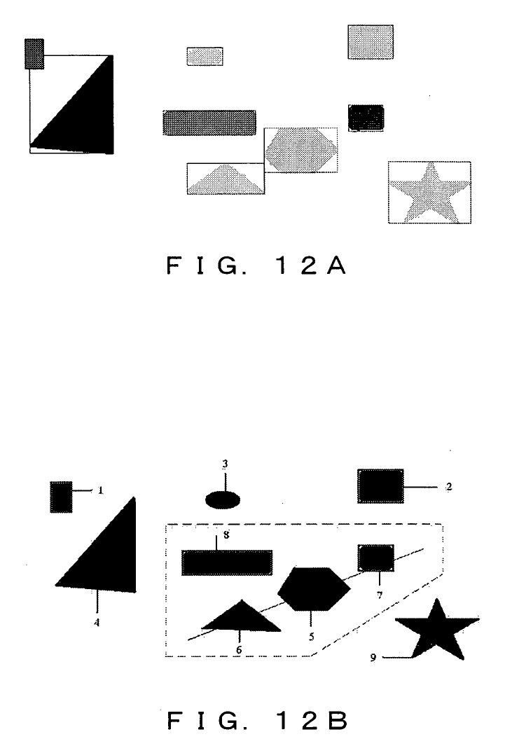

In the device part extraction unit, the device part images are extracted from all of the non-text areas. FIG. 12(a) shows the area of the obtained device part images, which are indicated by rectangles.

Finally, the query device part image and the extracted device part images are compared in the device part comparison unit. FIG. 12(b) shows the comparison results, and the rectangles indicate the existence of the query device part image in the input assembly drawing.

What is claimed is:

1. A device part image search device for collating an image of a device part in a technical drawing and a query image, comprising:
an extraction unit for extracting device part image areas wherein parts which should be segmented are divided based on proximity within the technical drawing; and
a collation unit for collating the query image and the extracted device part image area.

2. A device part image search device for collating an image of a device part in a technical drawing and a query image, comprising:
a segmentation unit for detecting lines drawn in the technical drawing and dividing the technical drawing into one or more sub-areas;
a non-text area determination unit for determining whether or not the sub-area is a text area comprising mainly text or a non-text area comprising mainly content other than text;
an extraction unit for extracting device part images from the non-text areas; and
a collation unit for collating the query image and the extracted device part image.

3. A device part image search device according to claim 2, further comprising blank detection orientation correction unit for detecting blank areas in said technical drawing and correcting the orientation of the technical drawing.

4. A device part image search device according to claim 2, wherein said segmentation unit generates a projection histogram, wherein pixels of a technical drawing are projected horizontally or vertically, and detects lines from the characteristic of peaks in the projection histogram.

5. A device part image search device according to claim 4, wherein sub-areas which are not actually divided by lines are merged so that segmentation of a technical drawing by sub-areas generated by line detection is the same as area segmentation by lines in the actual technical drawing.

6. A device part image search device according to claim 2, wherein said non-text area determination unit determines whether or not a sub-area is a text area or a non-text area by detecting the propensity of the distribution of a connected component of pixels comprised in each sub-area to be comprised in a band-like area of the sub-area.

7. A device part image search device according to claim 6, wherein the border lines of said band-like area are detected by generating a horizontal or vertical projection histogram for each sub-area, smoothing the projection histogram, and detecting the maxima and the minima of the smoothed projection histogram.

8. A device part image search device according to claim 6, wherein said non-text area determination unit determines whether an area is a non-text area or a text area by calculating the dimensional uniformity which indicates how much the width of said connected component differs in relation to the width of said band-like area, covering uniformity which indicates how much the location and width of the connected component differs in relation to the band-like area, and the maximum/minimum ratio which indicates how small the ratio of the minimum value is to the maximum value of pixel values of the connected components comprised in the band-like area.

9. A device part image search device according to claim 2, wherein said extraction unit divides a non-text area, corresponding to a white region comprised in the non-text area, and extracts the image area of a device part segment from an assembly drawing of a device.

10. A device part image search device according to claim 9, wherein said extraction unit further performs contour detection on an image in said device part segment, performs merging of part images which are integrated, and at the same time, performs separation of parts to be separated.

11. A device part image search device according to claim 2, wherein said collation unit divides said device part image in the radial direction and the angular direction, calculates a pixel value for each grid, and uses the Euclidean distance of a feature quantity vector of the device part image, obtained by performing Fourier transformation on a vector generated by the calculated pixel value, and a feature quantity vector obtained similarly for a query image as a gauge for similarity.

12. A device part image search method for collating an image of a device part in a technical drawing and a query image, comprising:
detecting lines drawn in the technical drawing, and dividing the technical drawing into one or more sub-areas;
determining whether or not the sub-area is a text area comprising mainly text or a non-text area comprising mainly content other than text;
extracting device part images in the non-text areas; and
collating the query image and the extracted device part image.

13. A program which enables an information processing device to perform a device part image search process wherein an image of a device part in a technical drawing and a query image are collated; and enables the information processing device to realize a device part image search method, comprising:
detecting lines drawn in the technical drawing, and dividing the technical drawing into one or more sub-areas;
determining whether or not the sub-area is a text area comprising mainly text or a non-text area comprising mainly content other than text;
extracting device part images in the non-text areas; and
collating the query image and the extracted device part image.
